(19) United States
(12) Patent Application Publication
(10) Pub. No.: US 2025/0218255 A1
(43) Pub. Date: Jul. 3, 2025

(54) ACTIVE INKING SYSTEM FOR SELF-SERVICE BANKING EQUIPMENT

(71) Applicant: TECNOLOGIA BANCÁRIA S.A., Barueri (BR)

(72) Inventor: EDSON IGOR CIFUENTES LOPES, São Paulo (BR)

(21) Appl. No.: 19/002,808

(22) Filed: Dec. 27, 2024

(30) Foreign Application Priority Data
Dec. 28, 2023 (BR) 102023027685-7

(51) Int. Cl. G07F 19/00; B41F 31/28

(52) U.S. Cl. CPC G07F 19/201; B41F 31/28; G07F 19/209

(57) ABSTRACT

An active inking system (1) secured to the payer module (25) of the self-service equipment is described. The active inking system (1) includes a modification to the upper cover (4) of the cassette (24), where three upper holes (5) and a front hole (6) are made; the upper holes (5) secure the spreader set (2) and the front hole (6) receives the male quick coupling (13) through which the ink (29) enters. The system (1) comprises a spark sensor (14), component securing structure (12), male quick coupling (13), ink cylinders (15), screws (16), ink outlet connections (20), activation trigger (17), CO₂ gas cylinders (18), tubes (19) and connections (21) for compressed gas. The spreader set (2) comprises a tank (10) aligned with the front hole (6) of the upper cover (4) of the cassette (24), the tank (10) in communication with the spreader tube (8) equipped with orifices (9) directed to the banknotes (7) through which the ink (29) is expelled to mark them. The sparks (27) activate the spark sensor (14), which activates the trigger (17), breaks the seal (28) of the CO₂ cylinder (18), pressurizes the tubes (19) for compressed gas, moves the front (22) and rear (23) plungers and pushes the ink (29).

### FIELD OF APPLICATION

This specification describes an invention that proposes an active inking system intended to be integrated as a security system in banking equipment, such as “ATM” (Automated Teller Machine) and “ATMR” (Cash Recycling ATM).

### INTRODUCTION

This invention proposes an active inking system for use in banking equipment, which was developed as a passively driven pressure inking system. The concept of this inking system enables rapid deployment and subsequent protection of banking equipment (ATM and ATMR) in localities where such banking equipment undergoes successive attacks.

### STATE OF THE ART

As is generally known, banking institutions have been offering their customers a number of facilities for several years, including the use of “ATMs” and “ATMRs”, which are external installations for self-service where different types of operations can be performed, the main ones being cash withdrawal and deposit.

Currently, self-service equipment is attacked in a variety of ways, such as, for example, using explosives or a variety of tools and methods such as cutting discs, torches, plasma, thermal lance, and etc.

Security that destroy or mark banknotes in case of attacks need a number of sensors to detect a given attack. Thus, these increasingly modern and intelligent systems require more than one type of sensor to confirm that a given event is a physical attack on the ATM. This causes the security device to be expensive, making installation unfeasible when a large number of ATMs needs to be protected.

### PROBLEMS WITH THE STATE OF THE ART

Security devices belonging to the state of the art feature drawbacks concerning the fact that they require installations inside the safe to accommodate the accessories, which include: sensors, controllers, cable routing and the actuator itself for destroying banknotes, which makes the installations time-consuming and expensive. Thus, localities frequently attacked would take months to be adequately protected.

Such devices belonging to the state of the art also feature drawbacks concerning the fact that they require maintenance and calibration of accessories, which makes the devices with this concept costly both for the acquisition and maintenance thereof.

### OBJECTIVES OF THE INNOVATION

In view of the drawbacks present in security equipment and systems belonging to the state of the art, the active inking system proposed herein was developed for use in banking equipment, which aims to be a more efficient alternative with lower deployment and maintenance cost when compared to equipment and systems currently in use.

Another object of this invention is to propose a security system for use in banking equipment that, in an innovative way, is based on passively driven pressure inking.

### ADVANTAGES

The “ACTIVE INKING SYSTEM FOR SELF-SERVICE BANKING EQUIPMENT” has as the main advantages being a mechanical and pneumatic system independent of electrical power, software or alarm system to be activated, which marks the banknotes with ink in order to render them unusable.

The system has simple and low-cost maintenance as it does not use electronic or electromechanical sensors.

### BRIEF DESCRIPTION OF THE INVENTION

The active inking system for self-service banking equipment, which is the object of this invention, includes ink spreader sets secured against the internal faces of the cassette upper covers, which function is to assist in the homogeneous distribution of ink over the banknotes to render them unusable; an inking set, secured on the bottom of the equipment module, consisting of an ink reservoir, a set of male quick couplings for the cassettes, attack detection sensors, CO₂ gas cylinders, cylinder activation trigger, connections and piping.

### BRIEF DESCRIPTION OF DRAWINGS

The active inking system for use in banking equipment, which is the object of this invention, may be fully understood in all its particulars from the detailed description that will be made based on the figures listed below, in which:

FIG. 1 shows a perspective view of the inking kit proposed herein.

FIG. 2 illustrates a general perspective view of the cassette, which is depicted in a cross-section view, in which the hole provided in the cassette cover can be seen and through which the ink is introduced into the spreader set to be dispersed over the stored banknotes in case of attack to the banking equipment.

FIG. 3 illustrates an isolated perspective view of the ink spreader set that is mounted under the upper cover of the cassette, said spreader set being illustrated so as to depict the lower face thereof.

FIG. 4 illustrates a view of the cassette cover, which is taken from its lower angle, demonstrating the internal face thereof against which the ink spreader set is mounted.

FIG. 5 illustrates a perspective view of the cassette, which is depicted in a cross-section view, so as to demonstrate the cassette with the ink spreader set mounted against the internal face of the cassette cover.

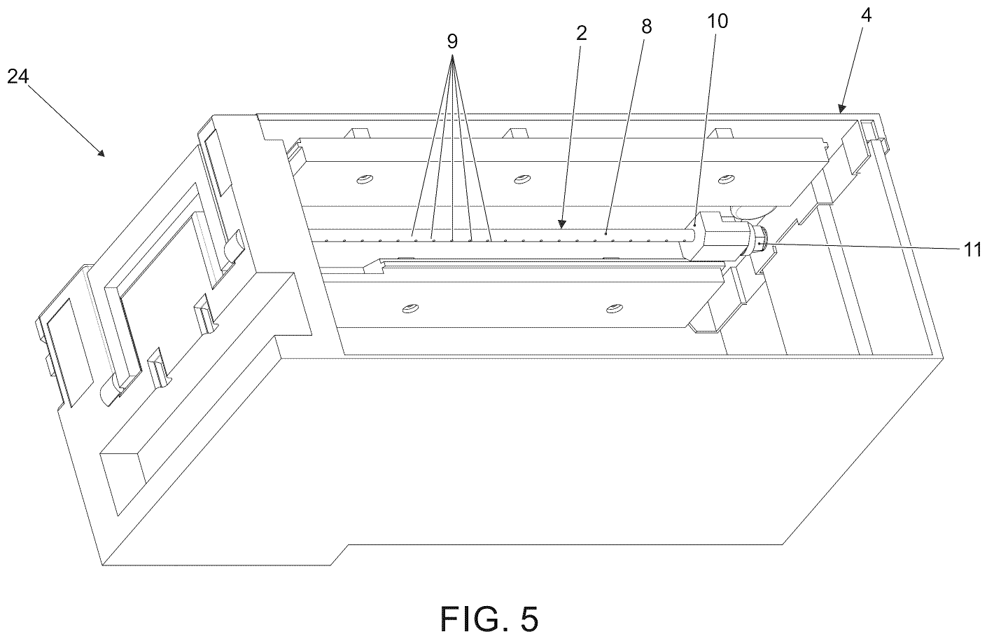

FIG. 6 illustrates a perspective view of the inking set that will be attached to the payer module.

FIG. 7 illustrates a lower view of the inking set.

FIG. 8 shows a perspective and cross-sectional view, as indicated by the cutting line “AA” in FIG. 7, of the ink reservoir cylinder, so as to demonstrate the internal components of said reservoir.

FIG. 9 illustrates a perspective view of the CO₂ gas cylinder used to pressurize the piping.

FIG. 10 illustrates a general perspective view of the payer module in which the banknote cassettes are positioned, as well as the mounted inking set depicted in FIG. 1, in which a condition of sparks appearing in the vicinity of the spark sensor is schematically shown.

FIG. 11 illustrates a cross-sectional view, as indicated by the cutting plane “B” in FIG. 10, to demonstrate the ink route from the coupling to the spreader set; and.

FIG. 12 illustrates an enlarged cross-sectional view of region “C” highlighted in FIG. 11.

### REFERENCE SIGNS

The “ACTIVE INKING SYSTEM FOR SELF-SERVICE BANKING EQUIPMENT” will be better described using the following reference signs:
(1) Active inking system
(2) Spreader set
(3) Inking set
(4) Upper cover
(5) Upper holes
(6) Front hole
(7) Banknotes
(8) Spreader tube
(9) Orifices
(10) Tank [for ink reception]
(11) Female quick coupling
(12) Component securing structure
(13) Male quick coupling
(14) Spark sensor
(15) Ink reservoir cylinders
(16) Screw [for securing the inking set]
(17) Activation trigger
(18) CO₂ gas cylinders
(19) Tubes for compressed gas
(20) Ink outlet connections
(21) Connections for compressed gas
(22) Front plunger
(23) Rear plunger
(24) Cassette
(25) Payer module
(26) Cavity
(27) Sparks
(28) Seal
(29) Ink
(30) Ink reservoir cover; and
(31) Hoses.

### DETAILED DESCRIPTION OF THE INVENTION

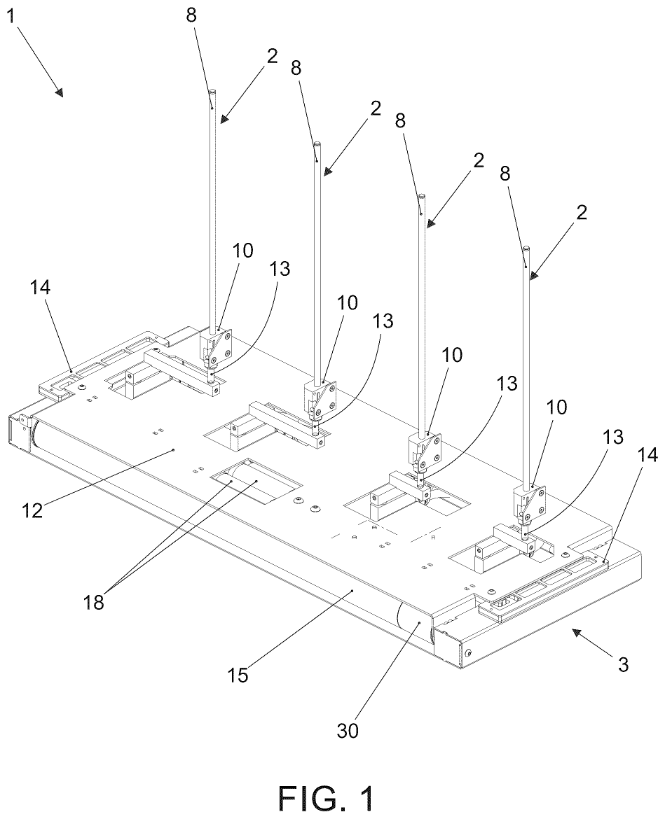

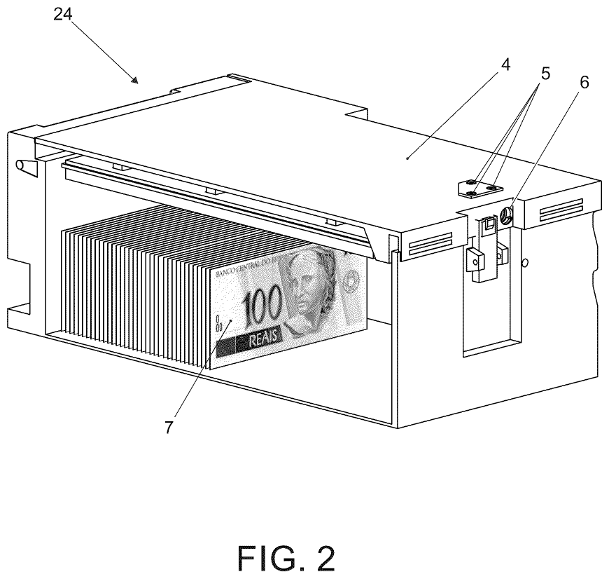

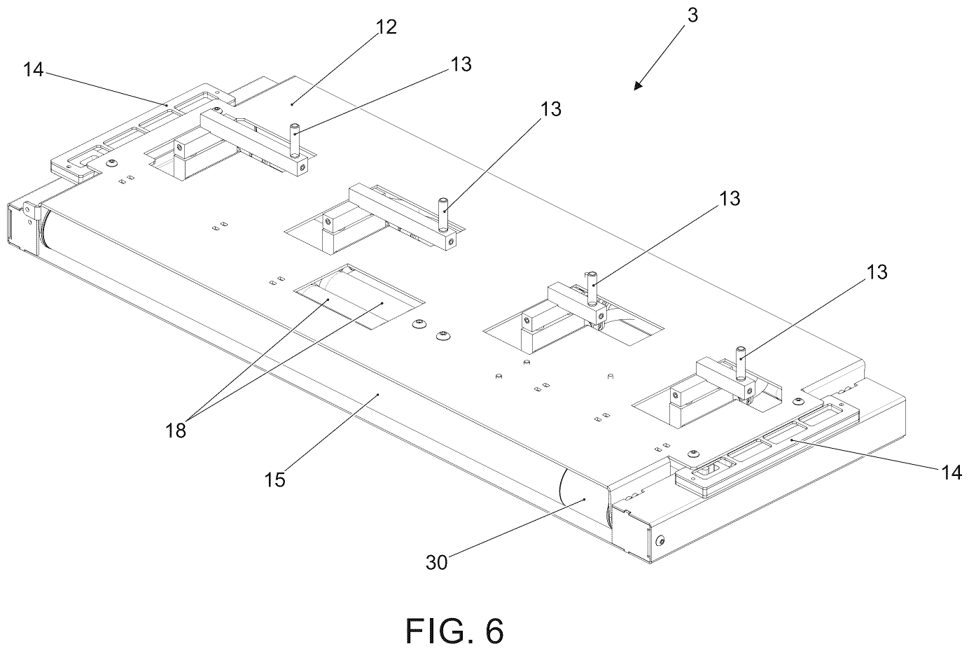

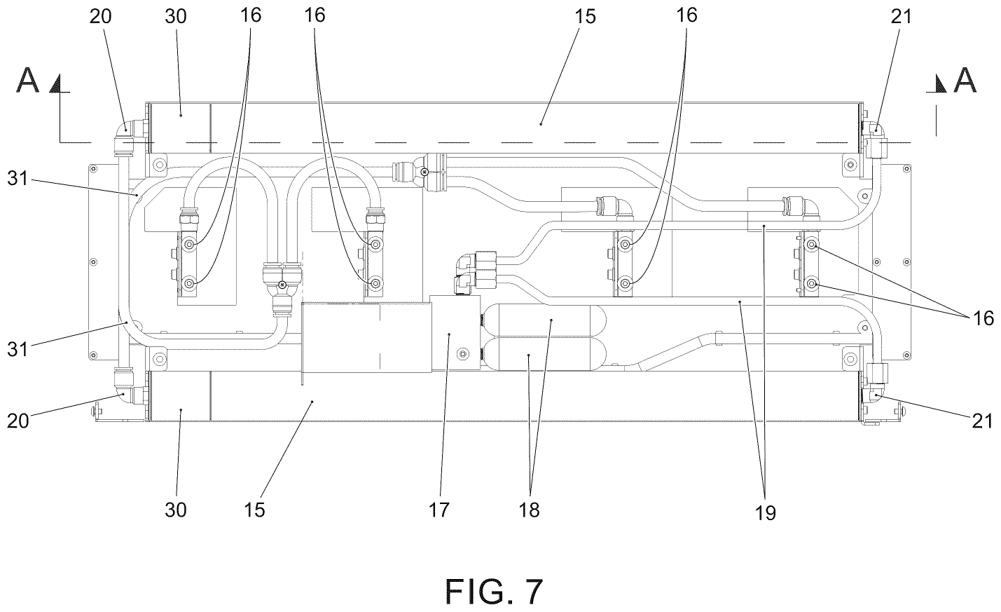

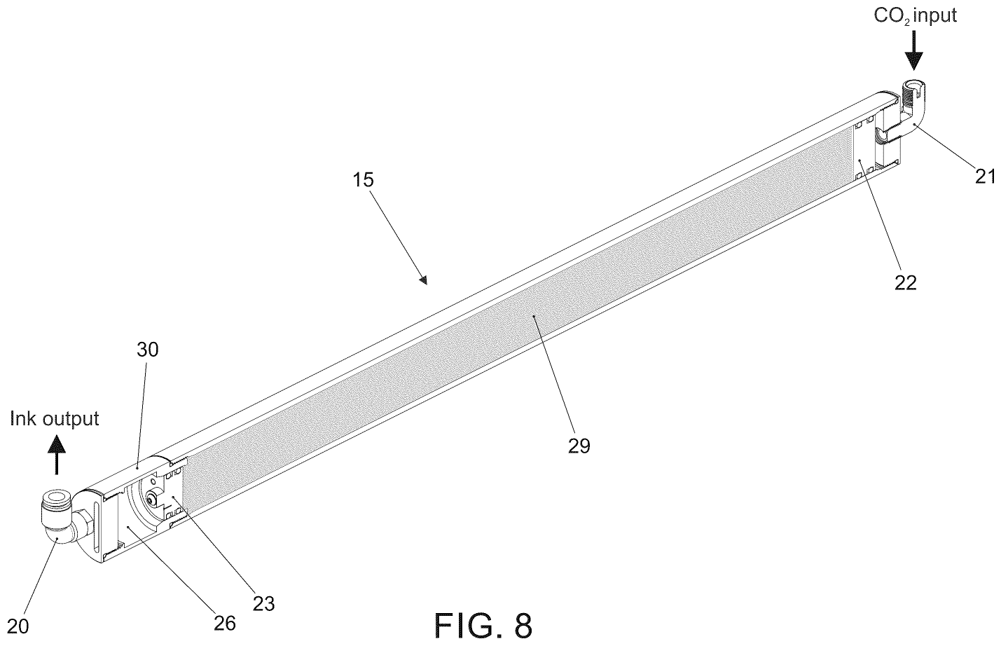

As illustrated in the figures listed above, the active inking system (1) for self-service banking equipment, which is the object of this invention (FIG. 1), includes a modification to the upper cover (4) of the cassette (24) (FIG. 2), which consists of drilling four holes, three upper holes (5) for securing the spreader set (2) and a front hole (6) (FIG. 2) through which the ink (29) that will mark the banknotes (7) will be introduced; said ink (29) will come from the ink reservoir cylinders (15) (FIGS. 6, 7 and 8), which are part of the inking set (3) of the active inking system (1) (FIG. 1), the ink (29) being contained between the front plunger (22) and the rear plunger (23) that prevent the ink (29) from coming into contact with the external environment, avoiding leaks and maintaining the ink (29) with original factory characteristics (FIG. 8).

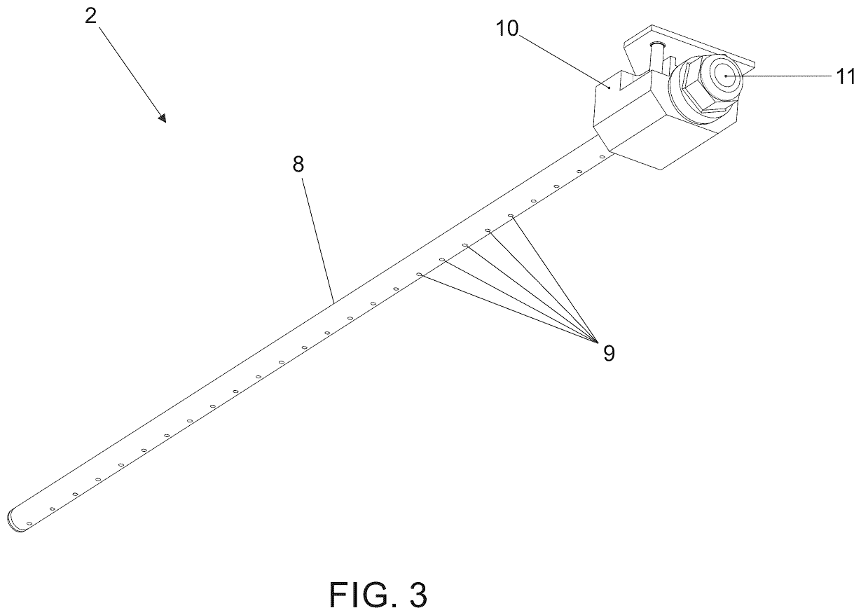

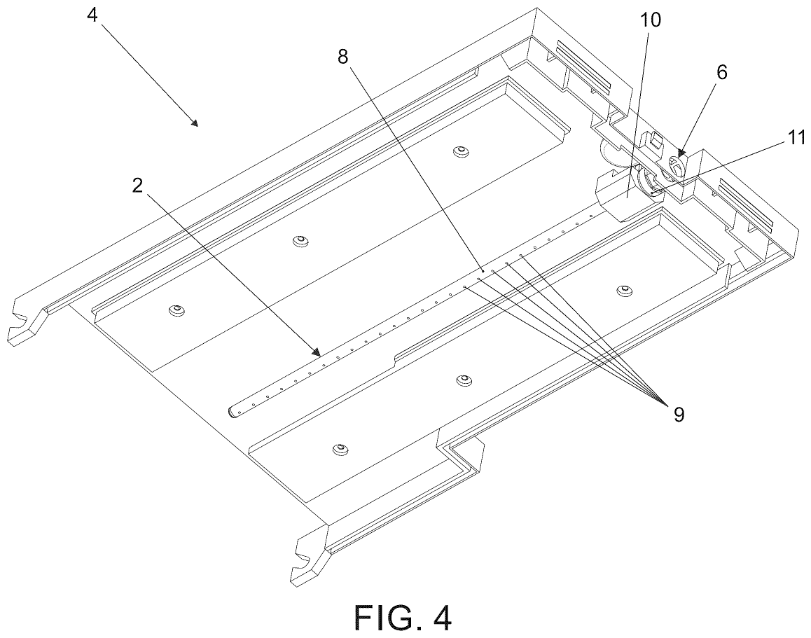

Still regarding the upper cover (4) of the cassette (24) shown in FIG. 2, it receives, on the internal face thereof, as shown in FIG. 4, the assembly of the spreader set (2), as illustrated in FIG. 3.

The ink (29) spreader set (2) comprises a female quick coupling (11), a small tank (10) for ink (29) reception and a spreader tube (8) provided with a number of orifices (9).

The female quick coupling (11) is aligned with the front hole (6) provided on the front face of the upper cover (4) of the cassette (24), as illustrated in FIGS. 2 and 4. The small tank (10) for ink (29) reception is in communication with the spreader tube (8) and the female quick coupling (11). The ink (29) enters through the female quick coupling (11), passes through the tank (10), reaches the spreader tube (8) and is expelled onto the banknotes (7) through the number of orifices (9) directed to the banknotes (7).

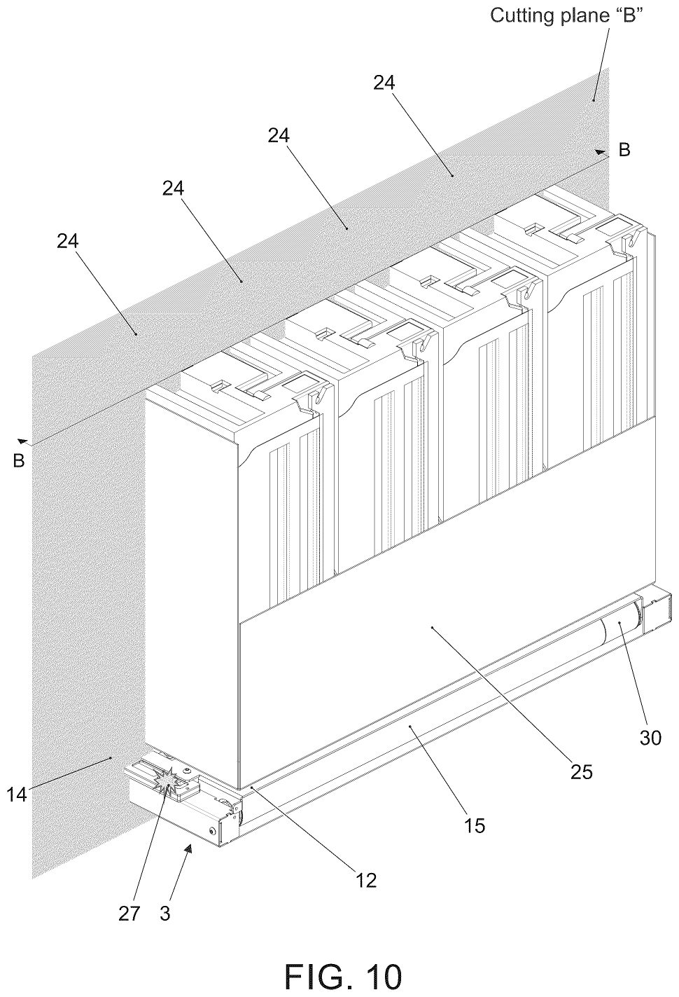

The inking set (3) illustrated in FIG. 1 is a device that is embedded in a piece called payer module (25), which is a device that integrates the infrastructure of the banking equipment; in said payer module (25) shown in FIG. 10, the cassettes (24) shown in FIG. 2 that store the banknotes (7) are housed.

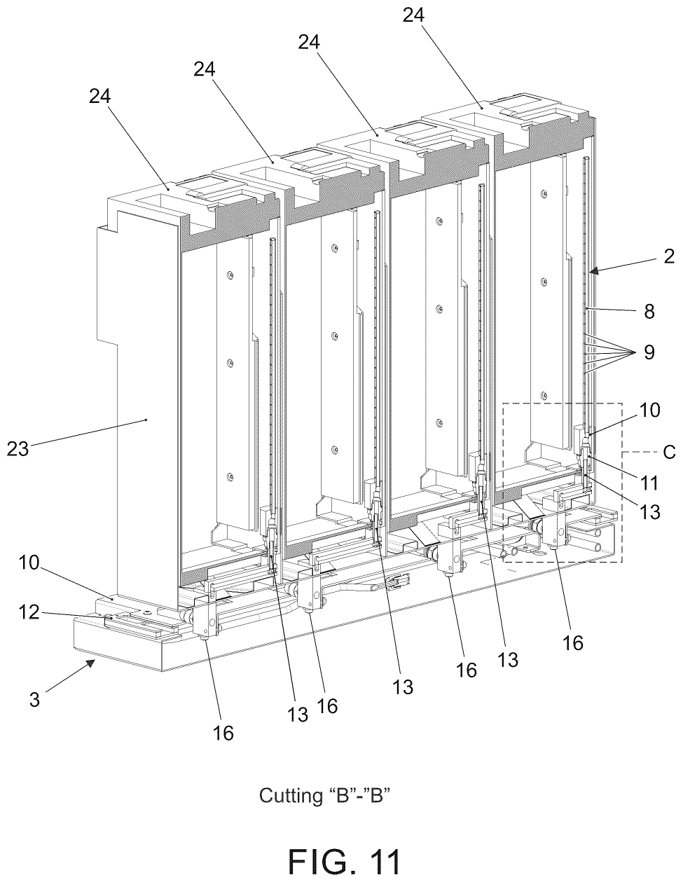

In order to install the inking set (3) (FIGS. 1, 3 and 6), no changes to the characteristics of the payer module (25) are required, as the existing holes are used, and the securing is done using screws (16) that make up the inking set (3) (FIG. 11).

The inking set (3) illustrated in FIGS. 1, 3 and 6 includes the following devices: component securing structure (12), a set of male quick couplings (13), spark sensor (14), ink reservoir cylinders (15), screws (16) for securing the inking set (3), activation trigger (17), CO₂ gas cylinders (18), tubes (19) for compressed gas, ink outlet connections (20), and connections for compressed gas (21).

The spark sensor (14) was developed to be sensitized when subjected to sparks (27) from a cutting disc, torch, thermal lance and plasma, among other equipment normally used by criminals during the process of breaching a banking equipment, whether it is an “ATM” or “ATMR”.

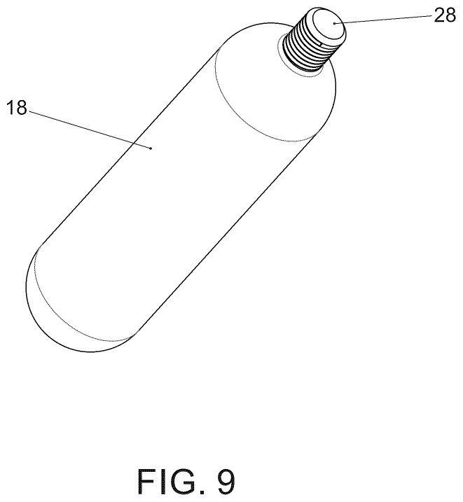

In order to benefit from the sparks (27) invariably generated during the process of breaching a banking equipment (FIG. 9), the spark sensor (14) is incorporated into the inking set (3).

The sparks (27) that are generated during the attacks sensitize the spark sensor (14) and, as a result, the activation trigger (17) breaks the seal (28) of the CO₂ gas cylinder (18) and consequently pressurizes the tubes (19) for compressed gas.

When the seal (28) of the CO₂ gas cylinder (18) is broken, the CO₂ gas is released and reaches the ink reservoir cylinder (15) through the tubes (19) for compressed gas and the connections (21) for compressed gas, and this gas pushes the front plunger (22), which pushes the ink (29) and, consequently, pushes the rear plunger (23).

When moving the rear plunger (23), it falls into a cavity (26) in the ink reservoir cover (30), allowing the ink (29) to pass towards the male quick coupling (13) through the hoses (31) and ink outlet connections (20) (FIG. 8).

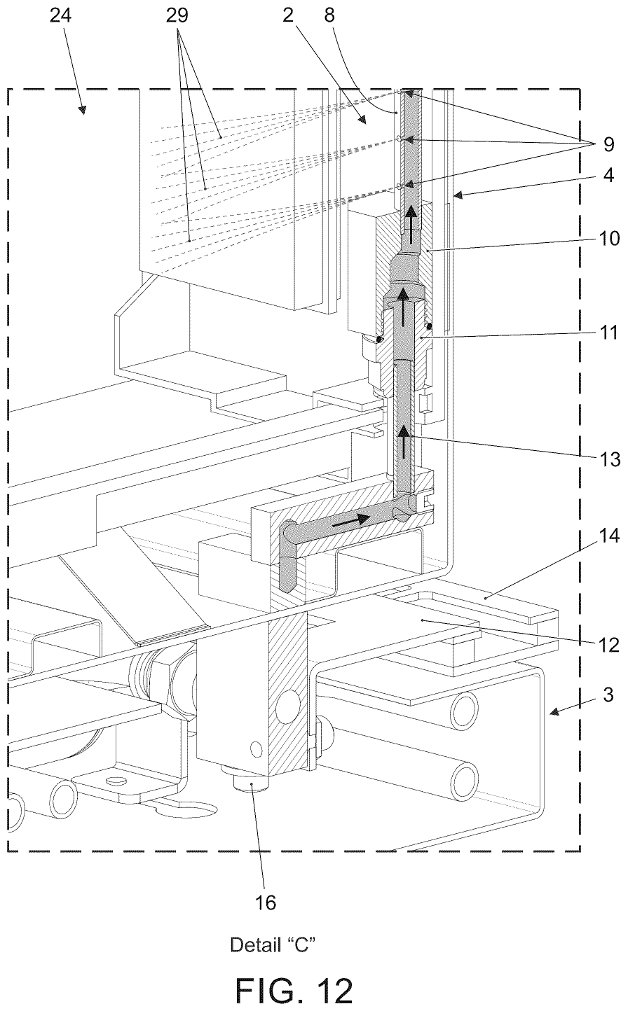

The ink outlet connections (20) and hoses (31) carry the ink (29) to the male quick coupling (13), which is connected to the cassette (24) (illustrated by FIGS. 1, 11 and 12), the ink (29) accesses the cassette (24) through the female quick coupling (11), passes through the tank (10) for ink (29) reception, reaches the spreader tube (8) of the spreader set (2) and, when exiting through the small orifices (9), spray the ink (29) and mark all the banknotes (7) (FIGS. 11 and 12).

As it is clear from the above, the fact that the active inking system (1) operates through the presence of sparks (27) (schematically illustrated in FIG. 10), which are generated at the time of breaching the banking equipment, makes the use of other types of sensors (whether electronic or electromechanical) unnecessary, thus eliminating, as a result, complicated and expensive maintenance procedures.

The active inking system (1) proposed herein is fully embedded into a single piece, which is secured to the payer module (25) of the self-service equipment (FIGS. 10 and 11). The system proposed herein does not have any electronic system to detect or activate the device and is independent of a battery or external power supply to activate or detect the attempted breach.

While the active inking system (1) for use in banking equipment, which is the object of this invention, was conceived, designed and developed for use in banking equipment such as “ATM” and “ATMR”, due to its independent nature from electronic and/or electromechanical technologies, the active inking system (1) can be used, with great positive effects, in any other type or model of banknote storage equipment.

1. “ACTIVE INKING SYSTEM FOR SELF-SERVICE BANKING EQUIPMENT”, consisting of a passively driven mechanical and pneumatic pressure inking system, wherein the active inking system (1) comprises a spreader set (2) secured against the internal face of the upper cover (4) of the cassette (24) and an inking set (3) secured to the bottom of the equipment module; the ink (29) spreader set (2) comprises a female quick coupling (11), a tank (10) for ink (29) reception aligned with the front hole (6) provided on the front face of the upper cover (4) of the cassette (24), said tank (10) for ink (29) reception in communication with the sprayer set (2), which has in the sprayer tube (8) a number of orifices (9) directed to the banknotes (7); the inking set (3) consists of a component securing structure (12), a set of male quick couplings (13), spark sensor (14), ink reservoir cylinders (15), screws (16), activation trigger (17), CO₂ gas cylinders (18), tubes (19) for compressed gas, ink outlet connections (20), and connections (21) for compressed gas; the inking set (3) is secured to the payer module (25) using screws (16) in existing holes in the payer module (25).

2. “ACTIVE INKING SYSTEM FOR SELF-SERVICE BANKING EQUIPMENT”, according to claim 1, wherein the spark sensor (14), when sensitized by the sparks (27), activates the activation trigger (17), which breaks the seal (28) of the CO₂ gas cylinder (18) that pressurizes the tubes (19) for compressed gas and the connections (21) for compressed gas, pushes the front plunger (22) that pushes the ink (29) that pushes the rear plunger (23) that falls into a cavity (26) provided in the ink reservoir cover (30) and allows the ink (29) to pass through the hoses (31), ink outlet connections (20), male quick coupling (13), female quick coupling (11), tank (10) for ink (29) reception, spreader tube (8) and exit through the orifices (9) in a sprayed way.
